(19) United States
(12) Patent Application Publication
(10) Pub. No.: US 2011/0080911 A1
(43) Pub. Date: Apr. 7, 2011

(54) Forwarding of Packets to a Same Location Having a Same Internet Protocol (IP) Address Embedded in a Different Advertised Route

(75) Inventors: Jim Guichard, New Boston, NH (US); Pradosh Mohapatra, Fremont, CA (US); Clarence Filsfils, Brussels (BE)

(73) Assignee: Cisco Technology, Inc., a corporation of California, San Jose, CA (US)

(21) Appl. No.: 12/573,088

(22) Filed: Oct. 2, 2009

(51) Int. Cl. H04L 12/56

(52) U.S. Cl. 370/392

(57) ABSTRACT

Routes advertised in a network may include an Internet Protocol (IP) address and one or more values to distinguish the route from other route(s) including the same IP address. Routes in a same context (e.g., within a same Virtual Private Network or for an entire network) with a same IP address are considered to refer to a same destination. When these routes are associated with different paths through a network, these different paths can be used to forward traffic for packets associated with routes including a same IP address (in a same context), particularly in response to a network problem.

### TECHNICAL FIELD

The present disclosure relates generally to communications systems.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology.

Border Gateway Protocol (BGP) is a routing protocol of the Internet that maintains a table of IP addresses (i.e., prefixes) which designate network reachability among autonomous systems (AS's). As used herein, the term “BGP” refers to all forms of BGP, including internal-BGP and external-BGP. Each BGP advertised route must be unique, otherwise, a subsequent advertisement of the route will consider it the same, and overwrite any previous information received about the route. BGP extensions advertise routes for a Virtual Private Network (VPN). A VPN-IPv4 address is a 12-byte string, beginning with an 8-byte Route Distinguisher (RD) and ending with a 4-byte IPv4 address. If several VPNs use the same IPv4 address prefix, these will be translated into unique VPN-IPv4 address prefixes, making it possible for BGP to carry several completely different routes to that IP address.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1A illustrates a network operating according to one embodiment;

FIG. 1B illustrates a network operating according to one embodiment;

FIG. 2A illustrates a network operating according to one embodiment;

FIG. 2B illustrates a network operating according to one embodiment;

FIG. 3 illustrates a network operating according to one embodiment;

FIG. 4 illustrates example advertised routes used in one embodiment;

FIG. 5 illustrates a process performed in one embodiment;

FIG. 6 illustrates a process performed in one embodiment; and

FIG. 7 illustrates an example system or component used in one embodiment;

### DESCRIPTION OF EXAMPLE EMBODIMENTS

### 1. Overview

Disclosed are, inter alia, methods, apparatus, computer-storage media, mechanisms, and means associated with forwarding of packets to a same location having a same Internet Protocol (IP) address (e.g., a specified address or address prefix) embedded in a different advertised route. One embodiment includes a method performed by a packet switching device. The packet switching device receives, from one or more other network devices, one or more route advertisement messages identifying multiple different Internet Protocol (IP) routes, with each of these different IP routes including one or more different values and a same IP address. These advertised routes include a first route and a second route. Packets are forwarded over one or more different paths through the network, with these different paths including a first path corresponding to the first IP route and a second path corresponding to the second IP route. The packet switching device identifies that the first and second paths have the same destination based on the same IP address embedded in the advertised first and second routes, and further based some identification that they belong to a same Virtual Private Network (VPN) to provide context to know that a same IP address refers to a same destination within said VPN. Subsequent to the packet switching device using the first path for sending packets associated with the first route (e.g., packets having a destination address of the first route), the router uses the second path for sending packets associated with the first route as the packet switching device has identified that they lead to the same destination. For example, the second path is configured to be a backup path for the first path based on the identification that they lead to the same destination. Thus, for example, these paths can be used with Prefix Independent Convergence or other fast convergence technique, to quickly respond to a network problem.

### 2. Description

Disclosed are, inter alia, methods, apparatus, computer-storage media, mechanisms, and means associated with forwarding of packets to a same location having a same Internet Protocol (IP) address embedded in a different advertised route. Embodiments described herein include various elements and limitations, with no one element or limitation contemplated as being a critical element or limitation. Each of the claims individually recites an aspect of the invention in its entirety. Moreover, some embodiments described may include, but are not limited to, inter alia, systems, networks, integrated circuit chips, embedded processing elements, ASICs, methods, and computer-readable media containing instructions. The embodiments described hereinafter embody various aspects and configurations within the scope and spirit of the invention, with the figures illustrating exemplary and non-limiting configurations. Note, computer-readable media and means for performing methods and processing block operations are disclosed and are in keeping with the extensible scope and spirit of the invention.

Note, the steps, connections, and processing of signals and information illustrated in the figures, including, but not limited to any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation).

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although any embodiment may include some, all or none of the features, elements and/or limitations described in relation to a particular different one embodiment. In addition, the terms “first,” “second,” etc. are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Note, nothing described or referenced in this document is admitted as prior art to this application unless explicitly so stated.

One embodiment includes a method performed by a packet switching device, the method comprising: receiving, by the packet switching device from one or more other network devices communicatively coupled in a network, one or more route advertisement messages identifying a plurality of different Internet Protocol (IP) routes, with each of the plurality of different IP routes including one or more different values and a same IP address, and with the plurality of different IP routes including a first IP route and a second IP route; forwarding a plurality of packets over one or more paths of a plurality of different paths through the network, with each of the plurality of different IP routes corresponding to a different one of the plurality of different paths; wherein the plurality of different paths includes a first path corresponding to the first IP route and a second path corresponding to the second IP route; and wherein said forwarding of the plurality of packets over said one or more paths of the plurality of different routes includes forwarding one or more packets associated with the first route over the first path; identifying, based on the first and second IP routes including the same IP address, that the first and second paths have a same destination; and subsequent to said forwarding one or more packets associated with the first route over the first path and responsive to said identification that the first and second paths have the same destination: forwarding one or more received packets corresponding to the first IP route over the second path.

In one embodiment, the packet switching device uses label switching with the first path being associated with a first label for forwarding packets from the packet switching device, and with the second path being associated with a second label for forwarding packets from the packet switching device; and wherein said forwarding one or more packets associated with the first route over the first path includes adding the first label to said one or more packets associated with the first route; and wherein said forwarding one or more received packets corresponding to the first IP route over the second path includes adding the second label to said one or more received packets corresponding to the first IP route. In one embodiment, said forwarding one or more received packets corresponding to the first IP route over the second path is performed in response to an identified problem with the first path.

One embodiment includes: prior to said forwarding one or more received packets corresponding to the first IP route over the second path, configuring the second path to be a backup path for the first IP route in response to said identifying, based on the first and second IP routes including the same IP address, that the first and second paths have the same destination; and switching the forwarding of packets corresponding to the first IP route to the backup path in response an identified problem with the first path. In one embodiment, the packet switching device uses label switching with the first path being associated with a first label for forwarding packets from the packet switching device, and with the second path being associated with a second label for forwarding packets from the packet switching device; and wherein said forwarding one or more packets associated with the first route over the first path includes adding the first label to said one or more packets associated with the first route; and wherein said forwarding one or more received packets corresponding to the first IP route over the second path includes adding the second label to said one or more received packets corresponding to the first IP route.

In one embodiment, each of the first and second IP routes is an IP Virtual Private Network (VPN) address associated with a same VPN providing a valid context for said operation of identifying, based on the first and second IP routes including the same IP address, that the first and second paths have the same destination; wherein routes of the plurality of different IP routes having an identical IP address but associated with a different VPN are not considered as having the same destination as different VPNs do not provide a valid context for comparing IP addresses embedded in routes. In one embodiment, each of said one or more different values in the first and second IP routes includes a different Route Distinguisher (RD). In one embodiment, said one or more route protocol route advertisement messages identify a same VPN Identifier (VPN ID) associated with each of the first and second IP routes identifying that the first and second routes belong to the same VPN. In one embodiment, said one or more route protocol route advertisement messages identify a same VPN Identifier (VPN ID) associated with each of the first and second IP routes identifying that the first and second routes belong to the same VPN. In one embodiment, said one or more route protocol route advertisement messages identify a same VPN route target associated with each of the first and second IP routes identifying that the first and second routes belong to the same VPN. In one embodiment, each of the first and second paths have a different next hop packet switching device in the network from the packet switching device. One embodiment includes: prior to said forwarding one or more received packets corresponding to the first IP route over the second path, configuring the second path to be a backup path for the first IP route in response to said identifying, based on the first and second IP routes including the same IP address, that the first and second paths have the same destination; and switching the forwarding of packets corresponding to the first IP route to the backup path in response an identified problem with the first path. In one embodiment, the packet switching device uses label switching with the first path being associated with a first label for forwarding packets from the packet switching device, and with the second path being associated with a second label for forwarding packets from the packet switching device; and wherein said forwarding one or more packets associated with the first route over the first path includes adding the first label to said one or more packets associated with the first route; and wherein said forwarding one or more received packets corresponding to the first IP route over the second path includes adding the second label to said one or more received packets corresponding to the first IP route.

In one embodiment, each of the first and second paths have a different next hop packet switching device in the network from the packet switching device. In one embodiment, the same IP address is an IP version 4 or IP version 6 address. In one embodiment, the packet switching device is configured to perform label switching for forwarding packets over the first and second paths. In one embodiment, said one or more route protocol route advertisement messages are Border Gateway Protocol (BGP) messages.

One embodiment includes a packet switching device, comprising: a plurality of communicatively-coupled interfaces configured for receiving and forwarding packets; one or more route processers configured for determining a forwarding information base (FIB) based on one or more route protocol advertisement messages received from one or more other network devices communicatively coupled in a network, with said one or more route protocol advertisement messages identifying a plurality of different Internet Protocol (IP) routes, with each of the plurality of different IP routes including one or more different values and a same IP address, and with the plurality of different IP routes including a first IP route and a second IP route; wherein the packet switching device is configured to forward a plurality of packets over a plurality of different paths through the network, with each of the plurality of different IP routes corresponding to a different one of the plurality of different paths; wherein the plurality of different paths includes a first path corresponding to the first IP route and a second path corresponding to the second IP route; and wherein said configuration of forwarding of the plurality of packets over the plurality of different routes includes forwarding one or more packets associated with the first route over the first path; wherein said one or more route processors are configured to identify, based on the first and second IP routes including the same IP address, that the first and second paths have a same destination; and wherein the packet switching device is configured to forward one or more received packets corresponding to the first IP route over the second path being responsive to said identification that the first and second paths have the same destination, and subsequent to said configuration of forwarding one or more packets associated with the first route over the first path.

In one embodiment, each of the first and second IP routes is an IP Virtual Private Network (VPN) address associated with a same VPN providing a valid context for said operation of identifying, based on the first and second IP routes including the same IP address, that the first and second paths have the same destination; wherein routes of the plurality of different IP routes having an identical IP address but associated with a different VPN are not considered as having the same destination as different VPNs do not provide a valid context for comparing IP addresses embedded in routes. In one embodiment, said one or more route protocol route advertisement messages associated with each of the first and second IP routes include one or more values identifying that the first and second routes belong to the same VPN. In one embodiment, the packet switching device is configured to use label switching with the first path being associated with a first label for forwarding packets from the packet switching device, and with the second path associated with a second label for forwarding packets from the packet switching device; and wherein said configuration of forwarding one or more received packets corresponding to the first IP route over the second path includes adding the second label to said one or more received packets. In one embodiment, the packet switching device is configured to use label switching with the first path being associated with a first label for forwarding packets from the packet switching device, and with the second path associated with a second label for forwarding packets from the packet switching device; and wherein said configuration of forwarding one or more received packets corresponding to the first IP route over the second path includes adding the second label to said one or more received packets.

One embodiment includes a packet switching device, comprising: means for receiving, by the packet switching device from one or more other network devices communicatively coupled in a network, one or more route protocol route advertisement messages identifying a plurality of different Internet Protocol (IP) routes, with each of the plurality of different IP routes including one or more different values and a same IP address, and with the plurality of different IP routes including a first IP route and a second IP route; means for forwarding a plurality of packets over a plurality of different paths through the network, with each of the plurality of different IP routes corresponding to a different one of the plurality of different paths; wherein the plurality of different paths includes a first path corresponding to the first IP route and a second path corresponding to the second IP route; and wherein said forwarding of the plurality of packets over the plurality of different routes includes forwarding one or more packets associated with the first route over the first path; means for identifying, based on the first and second IP routes including the same IP address, that the first and second paths have the same destination; and means for forwarding, responsive to said means for identifying that the first and second paths have the same destination, one or more received packets corresponding to the first IP route over the second path subsequent to forwarding one or more packets associated with the first route over the first path.

In one embodiment, each of the first and second IP routes is an IP Virtual Private Network (VPN) address associated with a same VPN providing a valid context for said operation of identifying, based on the first and second IP routes including the same IP address, that the first and second paths have the same destination; wherein routes of the plurality of different IP routes having an identical IP address but associated with a different VPN are not considered as having the same destination as different VPNs do not provide a valid context for comparing IP addresses embedded in routes. In one embodiment, said one or more route protocol route advertisement messages associated with each of the first and second IP routes include one or more values identifying that the first and second routes belong to the same VPN.

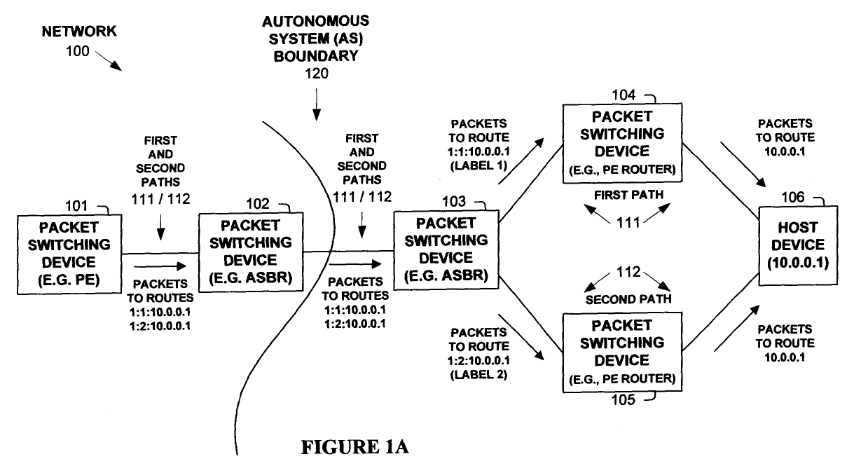

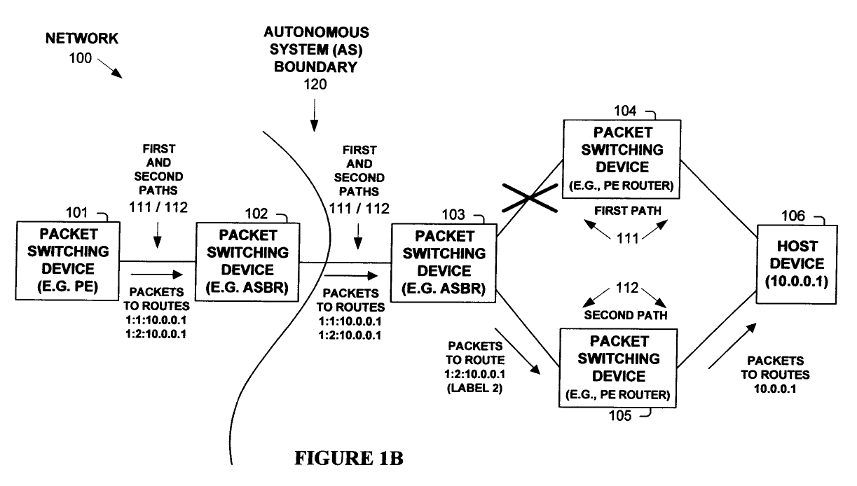

Expressly turning to the figures, FIG. 1A illustrates a network 100 operating according to one embodiment. Shown are packet switching devices 101-105, and host device 106 (e.g., a packet switching device, computer, or other networked device). These packet switching devices (101-105 and possibly 106) participate in one or more routing protocols (e.g., BGP) to establish routing of packets through network 100.

In this example, of interest are two routes labeled: 1:1:10.0.0.1 and 1:2:10:10.0.0.1. Embodiments may use different addressing formats or schemes, but when referring to a same destination include a same IP address (e.g., 10.0.0.1 in this example) plus some other value, such that within a certain context, a packet switching device can determine that although these are different advertised routes, they lead to a same destination as they include a same IP address (e.g., a specified address or address prefix), and within the context, means they lead to a same destination. In one embodiment, these routes correspond to VPN-IPv4 routes.

Packets associated with route 1:1:10.0.0.1 (e.g., to be sent to a destination address corresponding to 10.0.0.1) are forwarded over first path 111 to host device 106, while packets associated with route 1:2:10.0.0.1 are forwarded over second path 112 to host device 106. In one embodiment, one or more of packet switching devices 101-105 use label switching, with packet switching device 103 using outbound label 1 toward device 104 for first path 111 and outbound label 2 toward device 105 for second path 112 for sending associated packets from packet switching device 103. In one embodiment, packet switching device 103 is an Autonomous System Boundary Router (ASBR), with network 100 having AS boundary 120.

Note, for FIGS. 1A and 1B, the context of network 100 provides that a route including a same IP address will be for the same destination. As such, packet switching device 103 identifies that routes 1:1:10.0.0.1 and 1:2:10.0.0.1 go to the same destination. Moreover, packet switching device can configure its forwarding tables such that the path of one route is the backup path for the other route. Thus, Prefix Independent Convergence or another fast convergence mechanism can be used to quickly allow packet switching device 103 to adjust its forwarding of packets, especially responsive to network failures or other problem conditions at or to devices 104 and 105.

Furthermore, when at least packet switching devices 103-105 use label switching, packet switching device 103 could substitute one or more of the labels for paths 111 and 112 to quickly address a network problem associated with one of these paths (e.g., using Prefix Independent Convergence). Note, BGP or other routing protocols will react to network problems with the routing of network 100 accordingly adjusted, but this can take quite a long duration. Using one or more techniques described herein allows packet switching device 103 to quickly switch its forwarding of traffic from first path 111 to second path 112 (or vice versa), prior to the BGP convergence responsive to the network problem.

FIG. 1B illustrates an example of the operation of network 100 (e.g., also shown in FIG. 1A) when a network problem occurs in the forwarding path including first path 111, such as, but not limited to, being between packet switching device 103 and host device 106 (as illustrated by the ‘X’) or possibly with packet switching device 104. In response to the network problem, packet switching device 103 reacts by changing to forward traffic to destination 10.0.0.1 over second path 112. Packet switching device 103 is able to do so because in the context of network 100 of FIGS. 1A and 1B, a same IP address in different routes means that these different routes lead to the same destination. Therefore, packet switching device 103 is able to switch the forwarding of packets for destination 10.0.0.1 from first path 111 to second path 112, because path 112 was previously associated with route 1:2:10.0.0.1, which includes the same IP address (10.0.0.1) as route 1:1:10.0.0.1. In one embodiment, packet switching device 103 adds the label associated with second path 112 to packets associated with route 1:1:10.0.0.1 in response to a network problem or change in configuration affecting first path 111, where it previously was adding the label associated with first path 111 to packets associated with route 1:1:10.0.0.1.

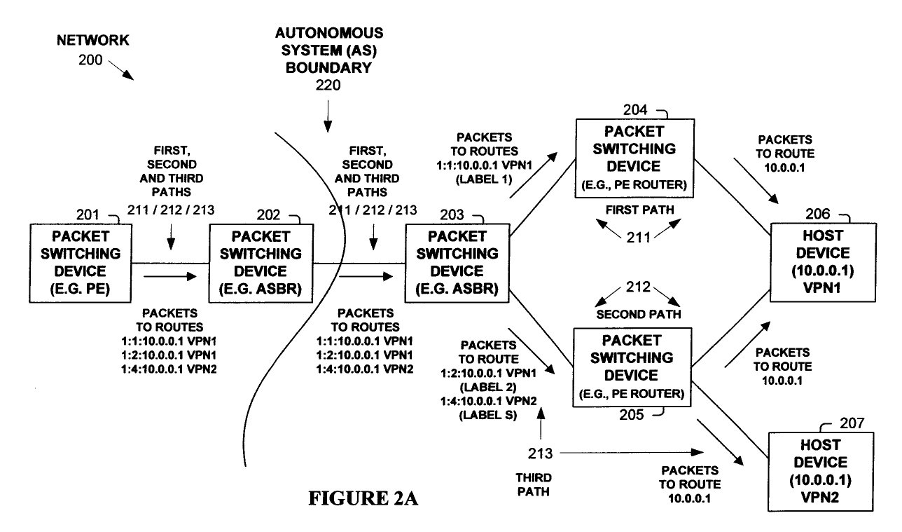

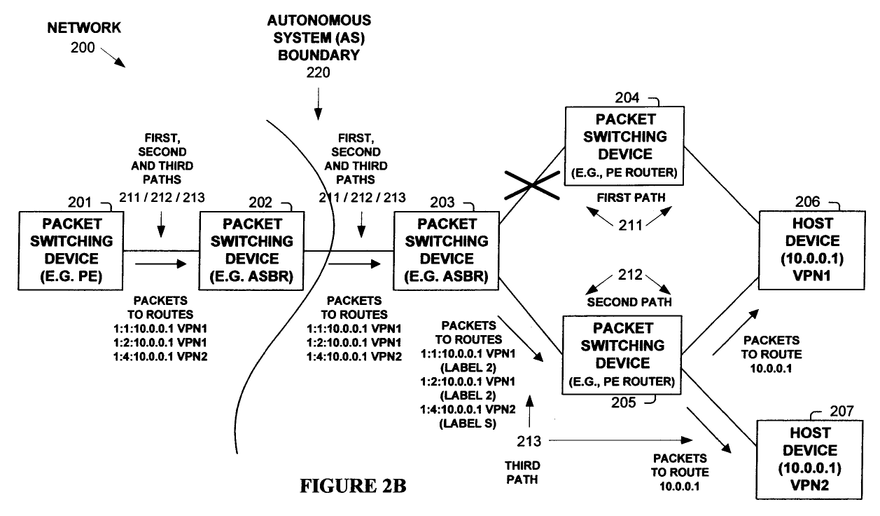

FIG. 2A illustrates a network 200 operating according to one embodiment. Shown are packet switching devices 201-205, and host devices 206 and 207 (e.g., packet switching device(s), computer(s), or other networked device(s)). In one embodiment, packet switching device 203 is an Autonomous System Boundary Router (ASBR), with network 200 having AS boundary 220. These packet switching devices (201-205 and possibly 206 and/or 207) participate in one or more routing protocols (e.g., BGP) to establish routing of packets through network 200.

In this example, of interest are two VPN-IPv4 routes 1:1:10.0.0.1 and 1:2:10:10.0.0.1 associated with a first VPN (VPN1), and a third VPN-IPv4 route 1:4:10.0.0.1 associated with a second VPN (VPN2). Note, IPv6 VPN routes are used in one embodiment.

Packets associated with route 1:1:10.0.0.1 of VPN1 are forwarded over first path 211 to host device 206; while packets associated with route 1:2:10.0.0.1 of VPN1 are forwarded over second path 212 to host device 206. Additionally, packets associated with route 1:4:10.0.0.1 of VPN2 are forwarded over third path 213 to host device 207.

In one embodiment, one or more of packet switching devices 201-205 use label switching, with packet switching device 203 using: outbound label 1 toward device 204 for first path 211 for route 1:1:10.0.0.1 of VPN1, outbound label 2 toward device 205 for second path 212 for route 1:2:10.0.0.1 of VPN1, and outbound label S toward device 204 for path 213 to host 207 for route 1:4:10.0.0.1 of VPN2.

Note, for FIGS. 2A and 2B, the context of network 200 does not provide that a route including a same IP address will be for the same destination. Rather, the VPN of which a route is associated provides the context for identifying that routes having a same IP address lead to a same destination. For example, shown in FIGS. 2A and 2B are three routes: 1:1:10.0.0.1 of VPN1, 1:2:10.0.0.1 of VPN1, and 1:4:10.0.0.1 of VPN2. Only those routes within a same VPN are in a context meaning that a same IP address embedded in a route means that they lead to a same destination. Therefore, packet switching device 203 can identify that routes 1:1:10.0.0.1 of VPN1 and 1:2:10.0.0.1 of VPN1 lead to a same destination (i.e., they include the same IP address 10.0.0.1 and are in the same VPN-VPN1); while route 1:4:10.0.0.1 of VPN2 cannot be considered as leading to a same destination as these other routes as it is in a different VPN, even though it includes the same IP address 10.0.0.1.

FIG. 2B illustrates an example of the operation of network 200 (e.g., also shown in FIG. 2A) when a network problem occurs in the forwarding path including first path 211, such as, but not limited to, being between packet switching device 203 and host device 206 (as illustrated by the ‘X’) or possibly with packet switching device 204. In response to the network problem, packet switching device 203 reacts by changing to forward traffic for route 1:1:10.0.0.1 over second path 212—as it is the path that route 1:2:10.0.0.1 of the same VPN is being forwarded. Again, packet switching device 203 is able to do so because in the context of a same VPN, a same IP address in different routes means that these different routes lead to the same destination. Therefore, packet switching device 203 is able to switch the forwarding of packets for route 1:1:10.0.0.1 from first path 211 to second path 212, because path 212 was previously associated with route 1:2:10.0.0.1, which includes the same IP address (10.0.0.1) of route 1:1:10.0.0.1 with both being in VPN1. In one embodiment, packet switching device 203 adds outbound label 2 toward device 205 associated with second path 212 to packets associated with route 1:1:10.0.0.1 of VPN1 in response to a network problem or change in configuration affecting first path 211, where it previously was adding outbound label 1 toward device 204 associated with first path 211 to packets associated with route 1:1:10.0.0.1 of VPN1.

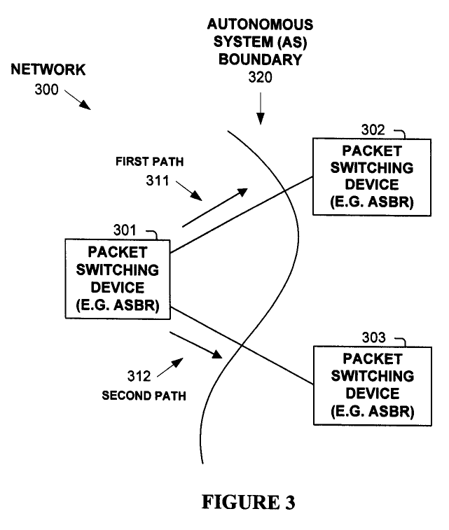

FIG. 3 illustrates network 300 operating according to one embodiment. In FIGS. 1A-B and 2A-B, the switching between first and second paths was done within a same Autonomous System (AS). FIG. 3 illustrates that this switching can occur between packet switching devices within different Autonomous Systems.

Illustrated in FIG. 3 is a network 300 including packet switching devices 301-303 (e.g., Autonomous System Boundary Routers), with Autonomous System Boundary 320. In one embodiment, packet switching device 301, operating as described herein such as, but not limited to, in relation to the other figures, causes packets to switch between first path 311 and second path 312, with each of these paths traversing AS Boundary 320 leading to different packet switching devices 302-303. This is possible for packets associated with different advertised routes, but leading to a same destination, as packet switching device 301 can identify that within a certain context, routes including a same IP address lead to a same destination as discussed herein.

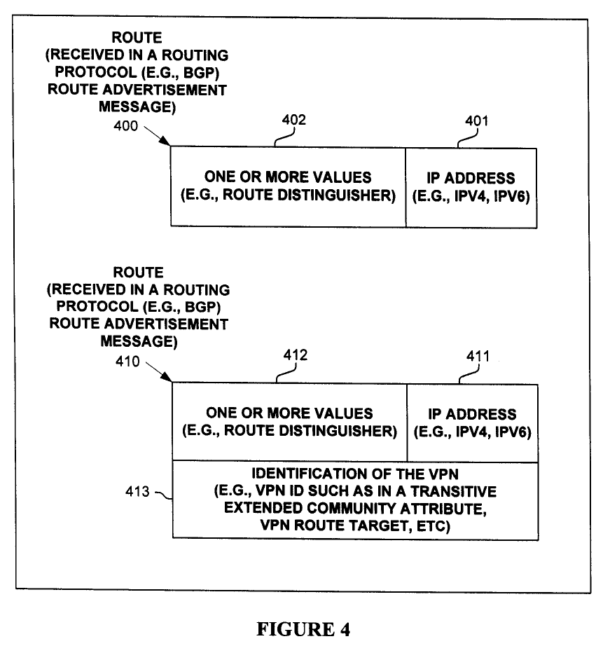

FIG. 4 illustrates two example advertised routes 400 and 410 of an extensible number of advertised routes. First, route 400 includes an IP address 401 (e.g., IPv4, IPv6), and one or more values 402 to distinguish the route 400 from other routes having a same IP address 401. In one embodiment, one or more values 402 includes, or consists of, a BGP Route Distinguisher.

Second, route 410 includes an IP address 411 (e.g., IPv4, IPv6), and one or more values 412 to distinguish the route 410 from other routes having a same IP address 411. In one embodiment, one or more values 412 includes, or consists of, a BGP Route Distinguisher. Additionally, route 410 is associated with an identification 413 of the VPN to which route 410 belongs. In one embodiment, this identification 413 of the VPN is a BGP Transitive Extended Community Attribute. In one embodiment, this identification 413 of the VPN is a BGP Route Target.

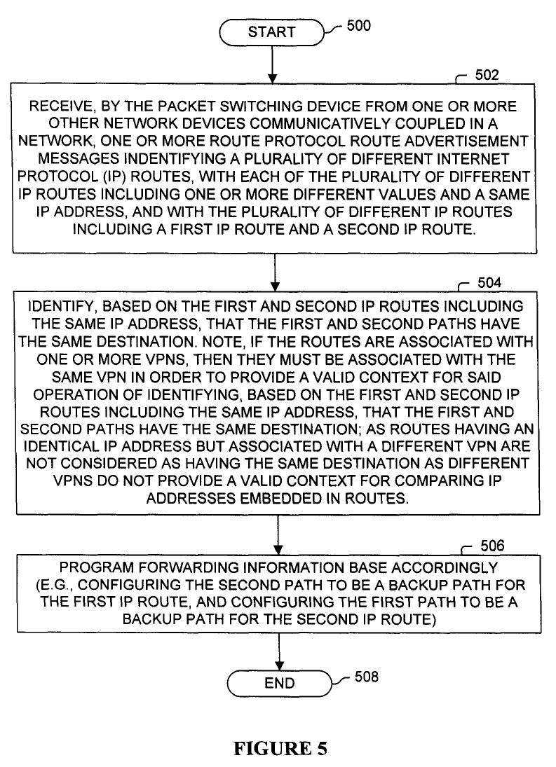

FIG. 5 illustrates a process performed in one embodiment. Processing begins with process block 500. In process block 502, the packet switching device receives routing protocol (e.g., BGP) messages, which include advertising of a first and second IP routes, with each including one or more different values and a same IP address. In process block 504, the packet switching device identifies that the first and second IP routes include a same IP address, and therefore, refer to a same destination. It can do so because the first and second routes are in a same context (e.g., all routes, within a same VPN) for making such identification; while routes in different VPNs are not in a same context. In process block 504, the forwarding information base is programmed accordingly for the routes. In one embodiment, the second path is configured as a backup path for the first IP route, and the first path is configured as a backup path for the second IP route. Processing of the flow diagram of FIG. 5 is complete as indicated by process block 508.

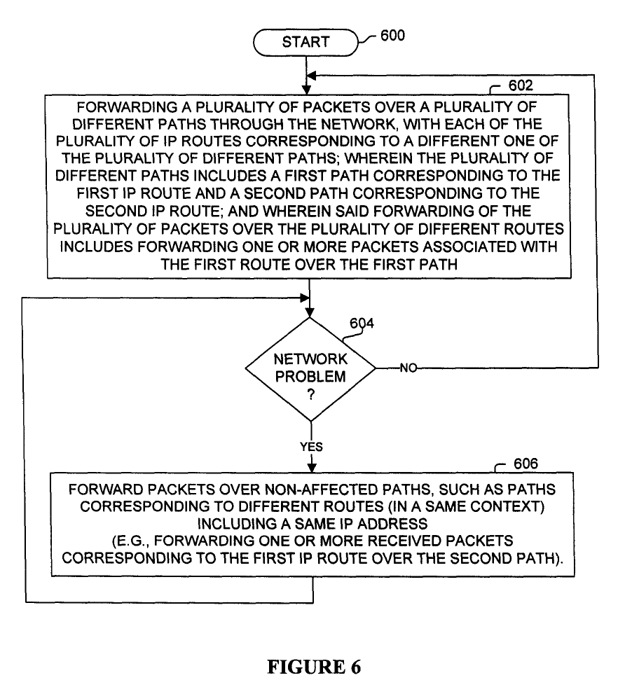

FIG. 6 illustrates a process performed in one embodiment. Processing begins with process block 600. In process block 602, packets are forwarded over multiple paths according to the routing information received (e.g., via BGP). This routing includes forwarding packets associated with a first route over the first path, and forwarding packets associated with a second route over a second route. As determined in process block 604, if there is no network problem, normal forwarding of packets continues in process block 602. Otherwise, in process block 606, one or more packets are forwarded over non-affected paths, such as paths corresponding to different routes including a same IP address and in a same context to identify that these routes refer to a same destination. Those paths identified as leading to a same destination (in a same context) can be used as needed to forward packets (e.g., one or more received packets corresponding to the first IP route are forward over the second path). In one embodiment, these alternative paths in the same context have been programmed as backup routes, so the operation of process block 606 is to switch to backup paths as required, such as, but not limited to, using Prefix Independent Convergence. Processing returns to process block 604 for determining how to forward more packets.

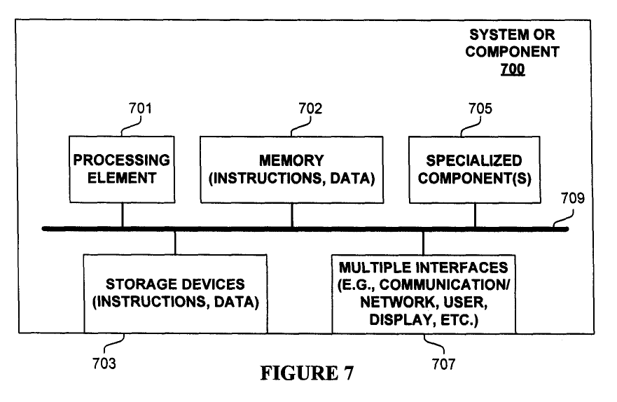

FIG. 7 is block diagram of a system or component 700 (such as a generalized view of a packet switching device, subsystem or component thereof) used in one embodiment associated with forwarding of packets to a same location having a same Internet Protocol (IP) address embedded in a different advertised route. In one embodiment, system or component 700 performs one or more processes or operations thereof, corresponding to one of the flow, block or other diagrams illustrated or otherwise described herein.

In one embodiment, system or component 700 includes a processing element 701, memory 702, storage devices 703, specialized components 705 (e.g. optimized hardware such as for performing lookup operations for identifying how to forward packets, etc.), and interface(s) 707 for communicating information (e.g., sending and receiving packets, user-interfaces, displaying information, etc.), which are typically communicatively coupled via one or more communications mechanisms 709, with the communications paths typically tailored to meet the needs of the application.

Various embodiments of component 700 may include more or less elements. The operation of component 700 is typically controlled by processing element 701 using memory 702 and storage devices 703 to perform one or more tasks or processes. Memory 702 is one type of computer-readable/computer-storage medium, and typically comprises random access memory (RAM), read only memory (ROM), flash memory, integrated circuits, and/or other memory components. Memory 702 typically stores computer-executable instructions to be executed by processing element 701 and/or data which is manipulated by processing element 701 for implementing functionality in accordance with an embodiment. Storage devices 703 are another type of computer-readable medium, and typically comprise solid state storage media, disk drives, diskettes, networked services, tape drives, and other storage devices. Storage devices 703 typically store computer-executable instructions to be executed by processing element 701 and/or data which is manipulated by processing element 701 for implementing functionality in accordance with an embodiment.

In view of the many possible embodiments to which the principles of our invention may be applied, it will be appreciated that the embodiments and aspects thereof described herein with respect to the drawings/figures are only illustrative and should not be taken as limiting the scope of the invention. For example, and as would be apparent to one skilled in the art, many of the process block operations can be re-ordered to be performed before, after, or substantially concurrent with other operations. Also, many different forms of data structures could be used in various embodiments. The invention as described herein contemplates all such embodiments as may come within the scope of the following claims and equivalents thereof.

What is claimed is:

1. A method performed by a packet switching device, the method comprising:
receiving, by the packet switching device from one or more other network devices communicatively coupled in a network, one or more route advertisement messages identifying a plurality of different Internet Protocol (IP) routes, with each of the plurality of different IP routes including one or more different values and a same IP address, and with the plurality of different IP routes including a first IP route and a second IP route;
forwarding a plurality of packets over one or more paths of a plurality of different paths through the network, with each of the plurality of different IP routes corresponding to a different one of the plurality of different paths; wherein the plurality of different paths includes a first path corresponding to the first IP route and a second path corresponding to the second IP route; and wherein said forwarding of the plurality of packets over said one or more paths of the plurality of different routes includes forwarding one or more packets associated with the first route over the first path;
identifying, based on the first and second IP routes including the same IP address, that the first and second paths have a same destination; and
subsequent to said forwarding one or more packets associated with the first route over the first path and responsive to said identification that the first and second paths have the same destination: forwarding one or more received packets corresponding to the first IP route over the second path.

2. The method of claim 1, wherein the packet switching device uses label switching with the first path being associated with a first label for forwarding packets from the packet switching device, and with the second path being associated with a second label for forwarding packets from the packet switching device; and wherein said forwarding one or more packets associated with the first route over the first path includes adding the first label to said one or more packets associated with the first route; and wherein said forwarding one or more received packets corresponding to the first IP route over the second path includes adding the second label to said one or more received packets corresponding to the first IP route.

3. The method of claim 1, wherein said forwarding one or more received packets corresponding to the first IP route over the second path is performed in response to an identified problem with the first path.

4. The method of claim 1, comprising:
prior to said forwarding one or more received packets corresponding to the first IP route over the second path, configuring the second path to be a backup path for the first IP route in response to said identifying, based on the first and second IP routes including the same IP address, that the first and second paths have the same destination; and
switching the forwarding of packets corresponding to the first IP route to the backup path in response an identified problem with the first path.

5. The method of claim 4, wherein the packet switching device uses label switching with the first path being associated with a first label for forwarding packets from the packet switching device, and with the second path being associated with a second label for forwarding packets from the packet switching device; and wherein said forwarding one or more packets associated with the first route over the first path includes adding the first label to said one or more packets associated with the first route; and wherein said forwarding one or more received packets corresponding to the first IP route over the second path includes adding the second label to said one or more received packets corresponding to the first IP route.

6. The method of claim 1, wherein each of the first and second IP routes is an IP Virtual Private Network (VPN) address associated with a same VPN providing a valid context for said operation of identifying, based on the first and second IP routes including the same IP address, that the first and second paths have the same destination; wherein routes of the plurality of different IP routes having an identical IP address but associated with a different VPN are not considered as having the same destination as different VPNs do not provide a valid context for comparing IP addresses embedded in routes.

7. The method of claim 6, wherein each of said one or more different values in the first and second IP routes includes a different Route Distinguisher (RD).

8. The method of claim 7, wherein said one or more route protocol route advertisement messages identify a same VPN Identifier (VPN ID) associated with each of the first and second IP routes identifying that the first and second routes belong to the same VPN.

9. The method of claim 6, wherein said one or more route protocol route advertisement messages identify a same VPN Identifier (VPN ID) associated with each of the first and second IP routes identifying that the first and second routes belong to the same VPN.

10. The method of claim 6, wherein said one or more route protocol route advertisement messages identify a same VPN route target associated with each of the first and second IP routes identifying that the first and second routes belong to the same VPN.

11. The method of claim 6, wherein each of the first and second paths have a different next hop packet switching device in the network from the packet switching device.

12. The method of claim 6, comprising:
prior to said forwarding one or more received packets corresponding to the first IP route over the second path, configuring the second path to be a backup path for the first IP route in response to said identifying, based on the first and second IP routes including the same IP address, that the first and second paths have the same destination; and
switching the forwarding of packets corresponding to the first IP route to the backup path in response an identified problem with the first path.

13. The method of claim 6, wherein the packet switching device uses label switching with the first path being associated with a first label for forwarding packets from the packet switching device, and with the second path being associated with a second label for forwarding packets from the packet switching device; and wherein said forwarding one or more packets associated with the first route over the first path includes adding the first label to said one or more packets associated with the first route; and wherein said forwarding one or more received packets corresponding to the first IP route over the second path includes adding the second label to said one or more received packets corresponding to the first IP route.

14. The method of claim 1, wherein each of the first and second paths have a different next hop packet switching device in the network from the packet switching device.

15. The method of claim 1, wherein the same IP address is an IP version 4 or IP version 6 address.

16. The method of claim 1, wherein the packet switching device is configured to perform label switching for forwarding packets over the first and second paths.

17. The method of claim 1, wherein said one or more route protocol route advertisement messages are Border Gateway Protocol (BGP) messages.

18. A packet switching device, comprising:
a plurality of communicatively-coupled interfaces configured for receiving and forwarding packets;
one or more route processers configured for determining a forwarding information base (FIB) based on one or more route protocol advertisement messages received from one or more other network devices communicatively coupled in a network, with said one or more route protocol advertisement messages identifying a plurality of different Internet Protocol (IP) routes, with each of the plurality of different IP routes including one or more different values and a same IP address, and with the plurality of different IP routes including a first IP route and a second IP route;
wherein the packet switching device is configured to forward a plurality of packets over a plurality of different paths through the network, with each of the plurality of different IP routes corresponding to a different one of the plurality of different paths; wherein the plurality of different paths includes a first path corresponding to the first IP route and a second path corresponding to the second IP route; and wherein said configuration of forwarding of the plurality of packets over the plurality of different routes includes forwarding one or more packets associated with the first route over the first path;
wherein said one or more route processors are configured to identify, based on the first and second IP routes including the same IP address, that the first and second paths have a same destination; and
wherein the packet switching device is configured to forward one or more received packets corresponding to the first IP route over the second path being responsive to said identification that the first and second paths have the same destination, and subsequent to said configuration of forwarding one or more packets associated with the first route over the first path.

19. The packet switching device of claim 18, wherein each of the first and second IP routes is an IP Virtual Private Network (VPN) address associated with a same VPN providing a valid context for said operation of identifying, based on the first and second IP routes including the same IP address, that the first and second paths have the same destination; wherein routes of the plurality of different IP routes having an identical IP address but associated with a different VPN are not considered as having the same destination as different VPNs do not provide a valid context for comparing IP addresses embedded in routes.

20. The packet switching device of claim 19, wherein said one or more route protocol route advertisement messages associated with each of the first and second IP routes include one or more values identifying that the first and second routes belong to the same VPN.

21. The packet switching device of claim 19, wherein the packet switching device is configured to use label switching with the first path being associated with a first label for forwarding packets from the packet switching device, and with the second path associated with a second label for forwarding packets from the packet switching device; and wherein said configuration of forwarding one or more received packets corresponding to the first IP route over the second path includes adding the second label to said one or more received packets.

22. The packet switching device of claim 18, wherein the packet switching device is configured to use label switching with the first path being associated with a first label for forwarding packets from the packet switching device, and with the second path associated with a second label for forwarding packets from the packet switching device; and wherein said configuration of forwarding one or more received packets corresponding to the first IP route over the second path includes adding the second label to said one or more received packets.

23. A packet switching device, comprising:
means for receiving, by the packet switching device from one or more other network devices communicatively coupled in a network, one or more route protocol route advertisement messages identifying a plurality of different Internet Protocol (IP) routes, with each of the plurality of different IP routes including one or more different values and a same IP address, and with the plurality of different IP routes including a first IP route and a second IP route;
means for forwarding a plurality of packets over a plurality of different paths through the network, with each of the plurality of different IP routes corresponding to a different one of the plurality of different paths; wherein the plurality of different paths includes a first path corresponding to the first IP route and a second path corresponding to the second IP route; and wherein said forwarding of the plurality of packets over the plurality of different routes includes forwarding one or more packets associated with the first route over the first path;
means for identifying, based on the first and second IP routes including the same IP address, that the first and second paths have the same destination; and
means for forwarding, responsive to said means for identifying that the first and second paths have the same destination, one or more received packets corresponding to the first IP route over the second path subsequent to forwarding one or more packets associated with the first route over the first path.

24. The packet switching device of claim 23, wherein each of the first and second IP routes is an IP Virtual Private Network (VPN) address associated with a same VPN providing a valid context for said operation of identifying, based on the first and second IP routes including the same IP address, that the first and second paths have the same destination; wherein routes of the plurality of different IP routes having an identical IP address but associated with a different VPN are not considered as having the same destination as different VPNs do not provide a valid context for comparing IP addresses embedded in routes.

25. The packet switching device of claim 24, wherein said one or more route protocol route advertisement messages associated with each of the first and second IP routes include one or more values identifying that the first and second routes belong to the same VPN.
